(19) United States
(12) Patent Application Publication
(10) Pub. No.: US 2015/0268671 A1
(43) Pub. Date: Sep. 24, 2015

(54) METHOD AND DEVICE FOR CHANGING A WATER LEVEL AND USE THEREOF IN THE SEPARATION OF SOLIDS FROM LIQUIDS

(71) Applicant: Rudolf Bischof GmbH Technische HV Abwassertechnik, Eching (DE)

(72) Inventor: Rudolf Bischof, Eching (DE)

(21) Appl. No.: 14/663,017

(22) Filed: Mar. 19, 2015

(30) Foreign Application Priority Data
Mar. 20, 2014 (DE) 10 2014 103 865.7

(51) Int. Cl. G05D 9/00; C02F 1/00

(52) U.S. Cl. CPC G05D 9/00; C02F 1/001

(57) ABSTRACT

A system and method for changing the water level in a channel in the region of a sieve or rake arrangement through which a liquid flows, to separate solids from said liquid. The system and method employ a damming body arranged in the flow direction behind the sieve or rake arrangement and laterally spaced from both channel sidewalls of the channel.

### CROSS-REFERENCE TO RELATED APPLICATION

This application claims priority under 35 U.S.C. §119(a) to German Patent Application No. 10 2014 103 865.7, filed on Mar. 20, 2014, the entire contents of German Patent Application No. 10 2014 103 865.7 are hereby incorporated herein by reference.

### BACKGROUND

1. Field of the Invention

The invention relates to a method for changing a water level in a channel in the region of a sieve or rake arrangement. The invention further relates to a separation process for removing solids from a liquid flow using such a method for changing a water level. The invention also relates to a water level changing device for changing the water level in a channel. Finally, the invention relates to a separation device for separating solids from a liquid flow comprising such a water level changing device.

2. Background Information

An inflatable rubber dam inflatable by a pressurized agent for damming flumes or channels is described in DE 1 297 039, where special measures are taken for sealingly connecting the rubber dam to walls or slopes of the channel in any posture of said rubber dam. Wastewater arriving at a sewage treatment plant usually contains a considerable amount of solids to be removed from the wastewater during the wastewater cleaning process. Sieve or rake arrangements, such as those described in EP 1 161 292 B1, DE 10 2007 035 081 A1, DE 10 2010 034 098 A1 or DE 10 2011 082 629 A1, are available for this purpose. The sieve or rake arrangements include, for instance, a grating or similar screen for mechanically screening the solids from the through-flowing liquid flow.

As described in EP 1 161 292 B2 an immersion pump is provided in the channel in the flow direction behind the sieve arrangement. Furthermore, DE 29 21 922 C2 describes a rake for wastewater cleaning in wastewater treatment plants including a bar sieve having a sieve rake arranged in a flow passage. For cleaning the bar sieve, the sieve rake lifted out from the bar sieve can be inserted into the bar sieve at the bottom thereof against the flow direction by means of a rotary crane and can then be lifted out and up. On the sieve rake, a first pressure plate is provided which during lifting-out is correspondingly inserted in the channel together with the sieve rake. This pressure plate together with the raked material is moved against a stationary further pressure plate above the channel in order to squeeze water from the raked material.

### SUMMARY

The present invention can be used particularly for adjusting the water level in the region of a sieve or rake arrangement to be installed for instance near or in wastewater treatment plants for separating solids from a wastewater flow.

Therefore, it is an object of the invention to provide a method and a device for improving the performance of a sieve or rake arrangement installed in a channel. This object is achieved by a method and device as defined in the claims.

According to a first aspect, the invention provides a method for changing the water level in a channel in the region of a sieve or rake arrangement through which a liquid flows, for separating solids from said liquid. The method comprises adjusting the water level of the tail water behind the sieve or rake arrangement by arranging a damming body in the flow direction behind the sieve or rake arrangement and laterally spaced from both channel sidewalls.

In a channel including such a sieve or rake arrangement or sieve or rake system through which a solid-fluid mixture flows, it often is an advantage if the water level behind the sieve or rake arrangement or the sieve or rake system (the level of the so-called tail water, shortly referred to as “tail water level”) is increased.

Due to the structural conditions in a wastewater treatment plant for example, the terrain directly behind the sieve or rake arrangement could be a downward slope, which causes a low tail water level. An excessively low tail water level affects the separating capacity of the sieve structures. For this reason, it is desirable to keep the level in the region of the sieve structure as high as possible. On the other hand, if the level is high, deposits may build up in the head water region ahead of the sieve or rake system.

Accordingly, a method is advantageously provided, for changing the water level in the region of the sieve or rake arrangement. The method is construed in such a manner that solids at the sieve or rake arrangement are retained much better, while the risk of deposits in the flow direction ahead of the sieve or rake arrangement in the channel is nevertheless reduced. Preferably, there is further provided a device for carrying out the method.

Preferably, the water level changing method comprises the step of: dividing the liquid flow at least into a first and a second branch flow by said damming body in such a manner that the first branch flow moves past the damming body between said damming body and one sidewall of the channel and the second branch flow moves past the damming body between said damming body and the other sidewall of the channel.

The water level changing method can comprise the step of changing an effective cross-section and/or the volume of the damming body, for damming. The water level changing method can also comprise the step of using a damming body expandable by a fluid pressure, and changing the fluid pressure. In addition, the water level changing method can comprises the step of using a damming body with a different damming cross-section in different orientations, and changing the orientation. Furthermore, the water level changing method can comprise the step of arranging the damming body centrally in the channel, along with arranging the damming body in a region approx 50 cm to approx 3 m (in the flow direction) behind the sieve or rake arrangement.

In a further aspect, the invention provides a separation process for separating solids form a liquid flow. The process comprises conducting the liquid flow through a sieve or rake arrangement to be inserted in a channel, and carrying out the water level changing method according to one of the preceding embodiments, for adjusting the level of the liquid in the region of the sieve or rake arrangement.

In still a further aspect, the invention provides a water level changing device for changing the water level in a channel in the region of a sieve or rake arrangement through which a liquid flows, for separating solids from said liquid. The device comprises a damming body and a mounting device for mounting the damming body in the flow direction behind the sieve or rake arrangement and away from the sidewalls of the channel in order to divide the liquid flow into a first branch flow and a second branch flow by said damming body in such a manner that the first branch flow moves past the damming body between said damming body and one sidewall of the channel and the other branch flow moves past the damming body between the said damming body and the other sidewall of the channel.

According to a first alternative, to change the effective damming cross-section, the damming body is variable in shape and/or position. It is also preferred that the damming body is expandable or contractible by adjusting a fluid pressure in the interior thereof and that the water level changing device includes a fluid pressure adjustment device for adjusting the fluid pressure inside the damming body.

According to a second alternative, the damming body presents a form having a different effective damming cross-section in different positions and/or orientations and that the mounting device is adjustable for changing the position and/or orientation of the damming body for the purpose of changing the effective damming cross-section.

In a further aspect, the invention provides a separation device for separating solids from a liquid flow, the device comprising a water level changing device according to one of the above-described embodiments and comprising a sieve or screen arrangement to be installed in the channel.

Further features and advantages of preferred constructions of the invention will be described as follows.

An excessively low tail water level in the flow direction behind the sieve or rake arrangement causes the following drawbacks. The hydraulic throughput of the sieve or rake system is low because the projected area that is passed by the fluid flow is decisive for the throughput. Also, due to the great water level difference between the head water level and the tail water level, the flow velocities between the bars or in the flow area are high. The consequence of high flow velocities is that a many solids that could be retained at low flow velocities, are urged through the sieve holes or sieve gaps. As a result, the separating capacity of the sieve or rake device is diminished.

With the preferred methods and devices herein proposed, these drawbacks can be removed by adjusting the water level in the region in the flow direction behind the sieve and rake arrangement, by means of a damming body.

Initially, it would be possible to provide the so-called “Venturi constrictions” already known per se from the practice for measuring flow capacities in channels in which the sidewalls of the channels are approached to each other in order to provide a constriction in the channel. A drawback of a so-called Venturi constriction is however that deposits are built up in the head water region ahead of the sieve or rake arrangement. Deposits ahead of sieve and rake systems or sieve and rake arrangements initially build up at the corners between the channel floor and the channel walls because the friction in this area is the highest and the flow rate accordingly the lowest. When damming bodies are additionally mounted to the channel sidewalls behind the sieve or rake arrangement or when the channel sidewalls themselves are constructed as such damming bodies, the flow rate at the sidewalls ahead of the sieve and rake arrangement is reduced one more time, which additionally increases the build-up of deposits. According to internal inspections of the channel floor, regular “sandbanks” would be formed on the channel floor sides ahead of the sieve arrangement or rake arrangement in such a case.

Therefore, in a preferred embodiment, it is proposed to attach a damming body not to the channel sidewalls, but spaced from both channel sidewalls. In this case, the liquid flows off between the damming body and the channel sidewalls. The flow velocity at the channel sidewalls is not decreased thereby, but is even increased.

According to a preferred embodiment, a damming body is installed in the channel center directly behind a sieve or rake arrangement.

Advantages of particular embodiments are that the flow velocity at the channel sidewalls is increased and that no or only little deposits are formed in the head water level region. Moreover, the hydraulic throughput of the grate of other sieve or rake arrangements is increased as a result of the higher tail water level.

Preferably, the damming body is one whose diameter and/or geometry can be changed automatically or manually. Accordingly, it is possible to adjust the effective damming cross-section in order to influence and/or change the water level and/or the flow velocities, whereby optimum conditions can be achieved.

In one embodiment, a damming body is used for this purpose, which can expand and contract by changing a fluid pressure inside the damming body. For example, a so-called channel shut-off bladder filled with air or water or with air and water can be installed perpendicularly to the flow direction and spaced from both channel sidewalls—e.g. in the channel center-behind the sieve or rake arrangement. The diameter is increased or decreasing by adding air or water or by removing air or water.

This increasing or decreasing operation can take place only manually or only automatically for example. For this purpose, channel shut-off systems or pipe stoppers can be used, which are commercially available for controlling such channel shut-off bladders.

By using a pipe stopper of the type RVD NV 400-1000 for example, which can be purchased from the applicant, the flow width of the channel can be reduced to 40 cm-100 cm with said stopper. In a channel, having a total width of 140 cm, the flow width can be changed in a continuously variable manner to from 140 cm to 100 cm-40 cm with such a pipe stopper.

In a different advantageous embodiment, a damming body is used that presents different effective damming cross-sections at a different orientation or different position. A triangular damming body for instance can be mounted in the center of the channel. Such a triangular damming body can be optionally provided with a hinge at the leading tip and can be provided with a motor-driven or hydraulic actuator for changing the upstream flow angle. As an alternative to this triangular damming body, a pyramidal damming body could be used for example.

### DESCRIPTION OF THE DRAWINGS

One embodiment of the invention will now be described in more detail with reference to the attached drawings, such that:

FIG. 1 illustrates a longitudinal section, seen in the flow direction, through a channel having inserted therein a separation device for separating solids from a liquid flow passing through the channel, the separation device being provided with a sieve or rake arrangement and a water level changing device;

FIG. 2 is a top view of the channel provided with the separation device of FIG. 1;

FIG. 3 provides a schematic representation of the channel including the head water level, the sieve grate, and the tail water level, for showing the variables for hydraulic calculations;

FIG. 4 illustrates a graph for illustrating the liquid passage as a function of the difference in height between the head water level and the tail water level at a height of the tail water level of 0.95 m;

FIG. 5 illustrates a graph for the velocity between the bars of the sieve grate of FIG. 3 as a function of the difference in height between the head water level and the tail water level at a tail water level of 0.95 m;

FIG. 6 illustrates a graph corresponding to FIG. 4, but at a tail water level of 0.3 m;

FIG. 7 illustrates a graph corresponding to FIG. 5, but at a tail water level of 0.3 m;

FIG. 8 illustrates an assortment of possible damming bodies without a device for changing the cross-section; and

FIG. 9 illustrates an assortment of possible damming bodies variable in cross-section by a device a cross-section changing device.

### DETAILED DESCRIPTION OF EMBODIMENTS

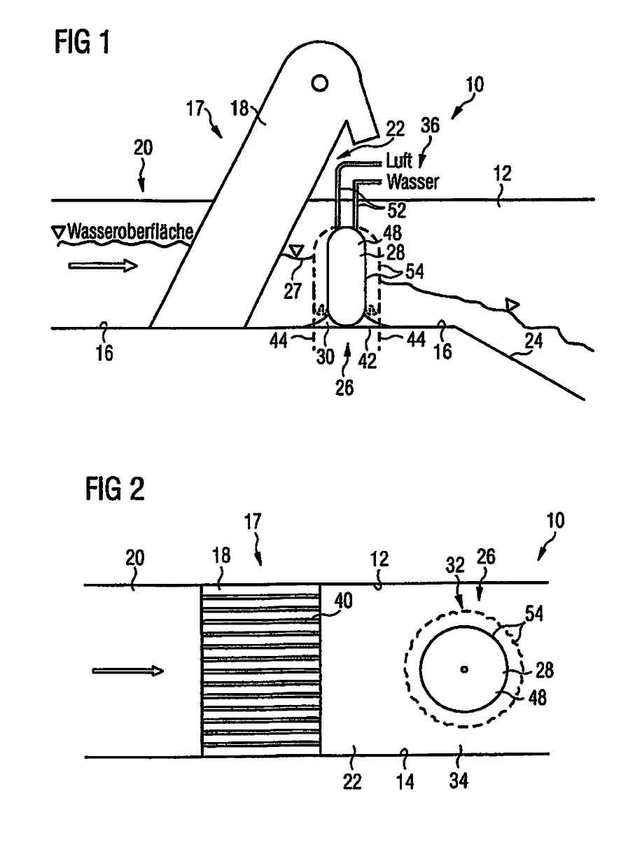

FIGS. 1 and 2 illustrate an example of a channel 10 used for conducting for example wastewater of a wastewater treatment plant not further shown. On the left and on the right said channel 10 is defined by sidewalls 12, 14 and on the lower side by a bottom 16.

For separating out solids inflowing with the wastewater, a separation device 17 is provided at the channel 10. The separation device 17 includes a sieve or rake arrangement 18. As a sieve or rake arrangement 18 there is used for example a sieve rake device as disclosed in DE 10 2011 082 629 A1. The sieve or rake arrangement 18 accordingly comprises a sieve rake 40 having bars or a similar sieve device (e.g. a perforated sheet).

The region of the channel 10 in the flow direction ahead of the sieve or rake arrangement 18 is referred to as head water 20 and the region of the channel 10 in the flow direction behind the sieve or rake arrangement 18 is referred to as tail water 22. In the region of the tail water 22, channel 10 includes a downward slope 24 via which slope the liquid, which is at least partially cleaned from solids by said sieve or rake arrangement 18, is conducted to further stages of the wastewater treatment plant.

The separation device 17 further includes a water level changing device 26 for changing the water level 17, Hu, in the tail water. The water level changing device 26 includes a damming body 28 fixed in the channel 10 in a region approx 50 cm to approx 3 m in the flow direction behind the sieve or rake arrangement 18, by means of a mounting device 30.

The mounting device 30 is constructed in such a manner that said damming body 28 is spaced both from the first sidewall 12 and the second sidewall 14 so that the damming body 28 divides the liquid flow into a first branch flow 32 between the damming body 28 and the first sidewall and a second branch flow 34 between the damming body and the second sidewall 14. The mounting device 30 includes for example a mounting plate 42 and screws 44 by which damming body 28 can be mounted at the bottom 16 of the channel 10.

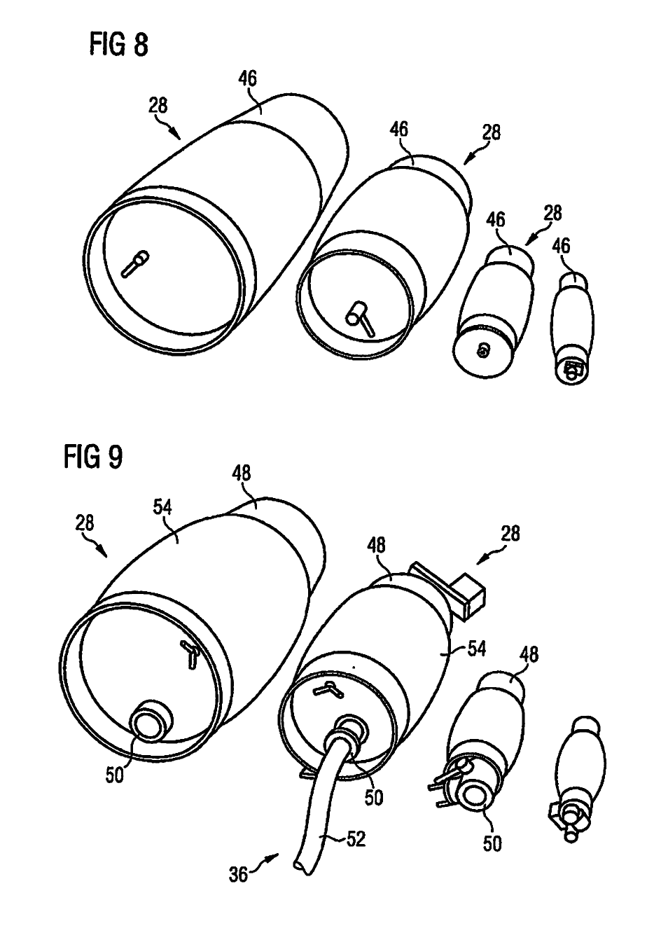

Examples of possible damming bodies 28 are shown in FIGS. 8 and 9. Bodies that have been devised as pipe stoppers 46 are preferably used as damming bodies 28. FIG. 8 shows various sizes of pipe stoppers 46 without special cross-section adjustment. FIG. 9 shows pipe stoppers 48 for the preferred use as damming body 28 which include a connector 50 to which a pressure fluid hose 52 can be connected. By introducing a pressurized fluid, for example air or water, the volume of the pipe stopper 48 can be varied.

Accordingly, the damming body 28 is preferably provided with a flexible envelope 54 and can be varied in its diameter by introducing a fluid such as air and/or water for example. The effective damming cross-section of the damming body 28 can be changed in this way. To this end, a fluid pressure adjustment device 36 is provided by which the fluid pressure inside the damming body 28 can be adjusted for correspondingly changing the diameter. In this manner, the flow areas of the first branch flow 32 and the second branch flow 34 can be increased or decreased.

A pipe stopper 48 of the type RVD NV 400-1000 is preferably used as a damming body 28. Such piper stoppers 48 are commercially available for a different intended use, namely for blocking and sealing pipes, and can be purchased among others from the applicant. Such pipe stoppers 46, 48, which are already offered on the market, are available with a fluid pressure adjustment device 36 for changing the diameter.

By the use of the damming body 28, the water level 27 of the tail water 22—tail water level—can be increased, which simultaneously increases the flow velocity in the region of the sidewalls 12, 14. In the following, the effects of damming the tail water level will be explained in more detail by way of calculation examples with reference to FIGS. 5 to 7.

As it is apparent from the following example of calculations for constant tail water 22 of at least 0.95 m on the one side and 0.3 m on the other side and from the corresponding graphs in FIGS. 5 to 7, by increasing the tail water level it is not only possible to increase the flow area through the sieve grate 40 and hence the flow rate, but also to reduce the velocity between the bars of the sieve grate 40. By inserting the damming body 28 for instance centrally, so that the flow velocity in the region of the sidewalls 12, 14 can be increased, the above-mentioned effects can be achieved without increasing the risk of deposits in the head water 20.

### 1. Calculation Example for Constant Tail Water Hu=0.95 m:

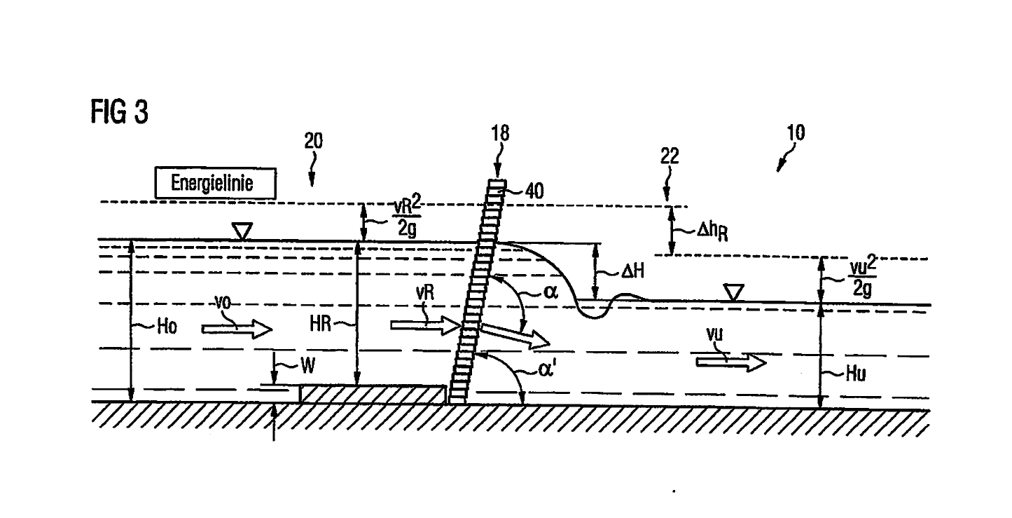

With the values graphically illustrated in FIG. 3 and shown in an exemplary manner in the following table 1, the following variables are obtained for the head water level, the water level difference and the energy difference for a tail water level Hu of 0.95 m.

The calculations are made using the following formulae:

Energy loss according to Kirschmer:

$$Δ {h}_{R} = \frac{{k}_{f}}{2 \cdot g} {( \frac{s}{a} )}^{4 / 3} \cdot sin α \cdot {v}_{R}^{2}$$

$$Δ {h}_{R} = {H}_{o} + \frac{{v}_{R}^{2}}{2 g} - {H}_{u} - \frac{{v}_{u}^{2}}{2 g}$$

Water level difference ΔH with loading B in %:

$$Δ H = {H}_{o} - {H}_{u} = \frac{{k}_{f}}{2 g} {( \frac{B / 100 + s / a}{1 - B / 100} )}^{4 / 3} \cdot sin α \cdot {v}_{R}^{2} - \frac{{v}_{R}^{2}}{2 g} + \frac{{v}_{n}^{2}}{2 g}$$

TABLE 1

| | | | | |
|---|---|---|---|---|
| Flow rate | Q | 500 | l/s | required |
| Loading | B | 30 | % | |
| Channel width | width | 1.000 | m | |
| Lateral frame width | SB | 0.000 | m | |
| Tail water depth | Hu | 0.950 | m | constant |
| Bottom step | W | 0.000 | m | |
| Max head water | HOₘₐₓ | 1.000 | m | upper limit |
| Bar thickness | s | 6 | mm | |
| Bar spacing | a | 6 | mm | |
| Shape coefficient | β | 0.76 | — | |
| Inclination angle | α | 75 | ° | 1.0 |

Perform Head water calculation
Calculation in mm steps

| | | | | |
|---|---|---|---|---|
| Result −> | Head water level | Ho | 0.973 | m |
| | Water level difference | ΔH = | 2.32 | cm |
| | Energy difference | Δh_{R} = | 2.25 | cm |
| | Number of bars | n = | 83 | |
| | Rake array width | Br = | 1.000 | m |
| | Flow width of rake | | 0.5020 | m |
| | Free area at Ho | A_{frei} | 0.4885 | m² |
| | without B | | | |
| | Velocity | vz = | 1.023 | m/s between |
| | | | | rake bars! |
| | Free area at | 0.7 | 0.3420 | m² |
| | loading B | | | |
| | vz at loading | vz_{B} = | 1.462 | m/s between |
| | | | | rake bars! |
| | Velocity ahead of rake | v_{R} | 0.514 | m/s in head water |
| | Velocity in tail water | vu = | 0.526 | m/s in tail water |
| | Distance to max height | | 2.68 | cm |

### 2. Calculation Example for Constant Tail Water Hu=0.3 m:

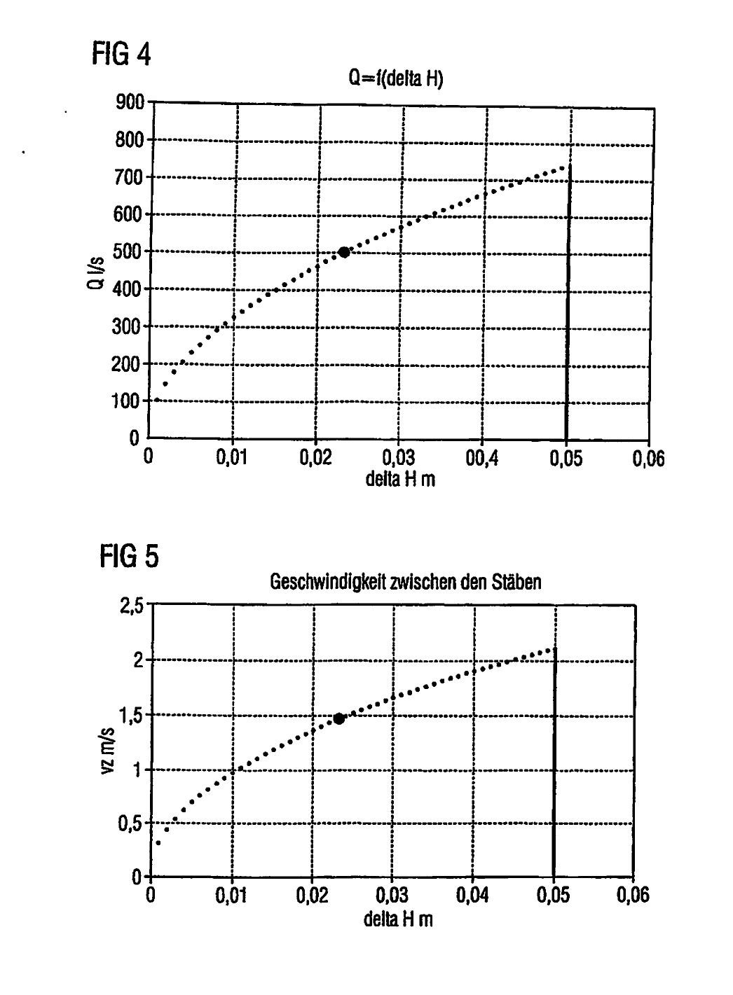

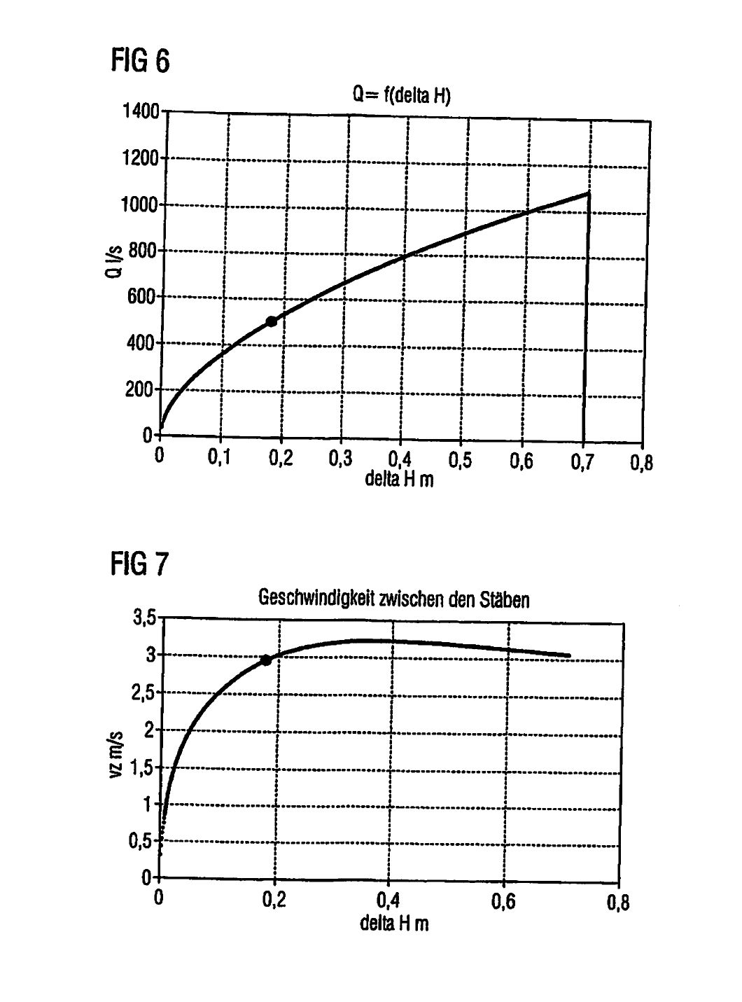

Table 2 shows the same calculation for a low tail water level Hu of 0.3 m. A comparison shows that by increasing the tail water level, a lower velocity between the bars of the sieve grate 40—also see a comparison of the graphs in FIGS. 4 and 5 on the one side with the FIGS. 6 and 7 on the other side—and better utilization of the sieve area can be obtained.

TABLE 2

| | | | | |
|---|---|---|---|---|
| Flow rate | Q | 500 | l/s | required |
| Loading | B | 30 | % | |
| Channel width | width | 1.000 | m | |
| Lateral frame width | SB | 0.000 | m | |
| Tail water depth | Hu | 0.300 | m | constant |
| Bottom step | W | 0.000 | m | |
| Max head water | HOₘₐₓ | 1.000 | m | upper limit |
| Bar thickness | s | 6 | mm | |
| Bar spacing | a | 6 | mm | |
| Shape coefficient | β | 0.76 | — | |
| Inclination angle | α | 75 | ° | 1.0 |

Perform Head water calculation
Calculation in mm steps

| | | | | |
|---|---|---|---|---|
| Result −> | Head water level | Ho | 0.479 | m |
| | Water level difference | ΔH = | 17.88 | cm |
| | Energy difference | Δh_{R} = | 9.32 | cm |
| | Number of bars | n = | 83 | |
| | Rake array width | Br = | 1.000 | m |
| | Flow width of rake | | 0.5020 | m |
| | Free area at Ho | A_{frei} | 0.2403 | m² |
| | without B | | | |
| | Velocity | vz = | 2.080 | m/s between |
| | | | | rake bars! |
| | Free area at | 0.7 | 0.1682 | m² |
| | loading B | | | |
| | vz at loading | vz_{B} = | 2.972 | m/s between |
| | | | | rake bars! |
| | Velocity ahead of rake | v_{R} | 1.044 | m/s in head water |
| | Velocity in tail water | vu = | 1.667 | m/s in tail water |
| | Distance to max height | | 52.12 | cm |

What is claimed is:

1. A method for changing a water level in a channel in a region of a sieve or rake arrangement through which a liquid flows to separate solids, the method comprising:
arranging a damming body in a flow direction of tail water behind the sieve or rake arrangement such that the damming body is laterally spaced from first and second channel sidewalls of the channel to adjust a water level of the tail water behind the sieve or rake arrangement.

2. The method according to claim 1, wherein the arranging comprising
positioning the damming body to divide the liquid flow into at least a first branch flow and a second branch flow such that the first branch flow moves past the damming body between the damming body and the first channel sidewall and the second branch flow moves past the damming body between the damming body and the second channel sidewall.

3. The method according to claim 1, further comprising
changing at least one of an effective cross-section of the damming body and a volume of the damming body.

4. The method according to claim 3, wherein the changing comprises at least one of the following
using the damming body that is configured to expand by fluid pressure, and changing the fluid pressure to change the volume of the damming body; and
using the damming body configured with different effective damming cross-sections in different orientations, and changing the orientation to change the effective cross-section of the damming body.

5. The method according to claim 1, wherein the arranging includes arranging the damming body centrally in the channel.

6. The method according to claim 1, wherein the arranging includes arranging the damming body in a region 50 cm to 3 m behind the sieve or rake arrangement.

7. The method according to claim 2, further comprising
changing at least one of an effective cross-section of the damming body and a volume of the damming body.

8. The method according to claim 7, wherein the changing comprises at least one of the following
using the damming body that is configured to expand by fluid pressure, and changing the fluid pressure to change the volume of the damming body; and
using the damming body configured with different effective damming cross-sections in different orientations, and changing the orientation to change the effective cross-section of the damming body.

9. The method according to claim 2, wherein the arranging includes arranging the damming body centrally in the channel.

10. The method according to claim 2, wherein the arranging includes arranging the damming body in a region 50 cm to 3 m behind the sieve or rake arrangement.

11. The method according to claim 1, further comprising
separating solids from the liquid flow after the arranging of the damming body to adjust the water level.

12. A water level changing system for changing a water level in a channel in a region of a sieve or rake arrangement through which a liquid flows, to separate solids from the liquid, the system comprising:
a damming body and a mounting device configured to mount the damming body in a flow direction of the liquid flow behind the sieve or rake arrangement and away from first and second channel sidewalls of the channel to divide the liquid flow into at least a first branch flow and a second branch flow such that the first branch flow moves past the damming body between the damming body and the first channel sidewall and the second branch flow moves past the damming body between the damming body and the second channel sidewall;
the damming body being configured as at least one of variable in shape to change an effective damming diameter of the damming body and as a form providing different effective damming cross-sections in different positions.

13. The water level changing system according to claim 12, wherein
the damming body is expandable and contractible by adjusting a fluid pressure in an interior of the damming body; and
the water level changing system further comprises a fluid pressure adjuster configured to the fluid pressure inside the damming body.

14. The water level changing system according to claim 12, wherein
the mounting device is further configured to change at least one of a position and orientation of the damming body to change the effective damming cross-section of the damming body.

15. The water level changing system according to claim 13, wherein
the mounting device is further configured to change at least one of a position and orientation of the damming body to change the effective damming cross-section of the damming body.
